(19) United States
(12) Patent Application Publication
(10) Pub. No.: US 2023/0312324 A1
(43) Pub. Date: Oct. 5, 2023

(54) NITROGEN INFUSING APPARATUS

(71) Applicant: TIMOTHY E. ORR, Redding, CA (US)

(72) Inventor: TIMOTHY E. ORR, Redding, CA (US)

(21) Appl. No.: 17/710,736

(22) Filed: Mar. 31, 2022

(51) Int. Cl. B67D 1/04; B67D 1/00; B67D 1/12

(52) U.S. Cl. CPC B67D 1/04; B67D 1/0047; B67D 1/0048; B67D 1/1204; B67D 2001/0481

(57) ABSTRACT

An apparatus for nitrogenizing a beverage utilizing a container having a chamber with a plurality of baffles. The container also includes a gas controller regulator in the form of a collapsible orifice at the base of the container. An agitator in the form of a rotating shaft creates a shear on the beverage during delivery of a stream of nitrogen gas into the container.

### BACKGROUND OF THE INVENTION

The present application provides a novel and useful apparatus for nitrogenizing a beverage such as tea or coffee.

“Cold brew coffee” has become a popular beverage and is prepared by steeping coffee grounds in cold water. Nitrogen has often been added to these beverages and other beverages, such as beer, tea, juices, milk, and the like. Such beverages may be nitrogenized with the apparatus of the present application.

Cold brew coffee is often packaged as a ready-to-drink item. As such, cold brew coffee is either packaged in a can or bottle or dispensed via a tap at a place of purchase.

Nitrogenized cold brew coffee may also be prepared and served or dispensed. To prepare nitrogenized cold brew coffee, unsweetened black coffee is infused or combined with nitrogen gas. Such a beverage is often referred to as “nitro cold brew” or “nitro coffee”. The introduction of nitrogen to cold brew coffee changes the appearance of the coffee from a heavy, dark, black liquor to a lighter colored, frothy, and creamy beverage. Consumers find nitro coffee to be visually and texturally appealing and desirable. Such a popularity is due to the taste of the nitro coffee since it is creamier and sweeter than the typical uninfused cold brew coffee.

In the past, nitrogenizing of cold brew coffee and other beverages have generally been limited to infusing the nitrogen before its distribution. For example, the prior dispensing of cold brew coffee places the beverage in a holding still followed by infusion with nitrogen. The beverage is then dispensed with a specific type of tap faucet referred to as a “stout faucet”. In other words, the prior methods for nitrogenization of cold brew coffee requires a special type of faucet for distribution.

Various prior art systems have been proposed to combine gaseous material with a liquid. For example, United States Patent Publication 2018/0318777 describes a liquid drink dispensing apparatus in which a gas generating component and a liquid drink dispensing element form an apparatus. The gas generated infuses a liquid drink prior to dispensing.

United States Patent Publication 2018/02113824 shows a technique and method for injecting a gas into a beverage. The beverage is placed into a container and a gas is pumped into the delivery device having a porous end portion to deliver the gas to the liquid.

U.S. Pat. No. 9,801,405 shows a method to prepare and dispense gaseous-infused beverages in which a beverage concentrate is utilized and mixed with a particular gas such as nitrogen or carbon dioxide. A slow pour faucet is then employed to deliver the infused liquid for use.

European patent specification EP2783743 shows a method for processing a fluid in which a gas is sparged into a fluid to form a humid gas. The humid gas is passed from the container into a condenser bag for cooling, which causes separation of the components into a condensed fluid in a dehumidified gas. The condensed fluid is then combined with components or recirculated back to the still.

Korean Publication KR1020160099794A teaches an apparatus to produce lotions, drops, gels, ointments, and the like by placing a fluid in a container with an impeller. Dissolved gasses are then added to infuse liquids in the container and produce a fluid with a large amount of nanobubbles.

International Publication WO2018/148843 illustrates the combination of a liquid by infusion of carbon dioxide into such liquid by mixing the same with a magnetic mixer.

International Publication WO2018/156361 involves a method of mixing a first beverage with a second beverage through the use of an external control system.

An apparatus for the infusion of nitrogen into a beverage and the production of near microscopic bubbles to produce a drink which exhibits superior flavor and visual appeal would be a notable step in the beverage processing industry.

### SUMMARY OF THE INVENTION

In accordance with the present application, a novel and useful apparatus for nitrogenizing a beverage by infusion of gaseous nitrogen from a source is herein provided.

The apparatus of the present application utilizes a container having a chamber for the beverage and is formed by a base and a side portion that extends from the base. The container is formed by a base a side portion extending therefrom. At least one baffle is located in the chamber and is positioned along the side portion of the container. The apparatus is also constructed with a lid from which at least one baffle, and preferably a multiplicity of baffles, depend. Thus, a multiplicity of baffles extend into the chamber of the container from the lid. Once in the container, the multiplicity of baffles are positioned along the inside wall portion of the side portion of the container.

A port, having an orifice, is located in the base of the container to control or regulate the passage of gaseous nitrogen from a source to a beverage in the chamber of the container. The port may be formed of a resilient element that is located at the base of the container. The flow of nitrogen gas from the source to the chamber of the container, via a support, causes enlargement of the orifice. Such enlargement is a result of the pressure of the nitrogen gas at the port orifice and serves to regulate the flow of nitrogen gas into the chamber into the container. Interruption of nitrogen gas to the port orifice closes the orifice and prevents the flow of nitrogen gas to the container chamber.

An agitator is also employed in the present apparatus. The agitator may take the form of a shaft which extends into the chamber of the container to create a shearing force on the beverage within the chamber of the container. The agitator is preferably positioned adjacent the port orifice, from which the nitrogen gas is emanating, and adjacent to the at least one baffle. A motor is employed to turn the shaft of the agitator and is mounted on a plate located apart from the container. The apparatus further includes a housing, which may be employed to aid in the positioning of the motor for turning the shaft. In certain instances, the motor mounted to the plate is located in the housing. Plate further includes a conical protrusion having an opening through the same. The lid of the container may be also provided with a concave fitting having an aperture to allow the shaft to extend into the chamber of the container. Thus, the plate protrusion opening aligns with the aperture through the concave fitting on the lid such that the shaft extends through the aperture of the concave fitting of the plate, the aperture of concave fitting, and into the chamber of the container.

A first conventional controller regulates the activity of the motor and the agitator while a second controller regulates rate of entry of the gaseous nitrogen through the port orifice at the base of the container. As heretofore stated, the orifice of the resilient port at the base of the container provides such regulation through the quantity of pressure of gaseous nitrogen fed to the resilient port.

A support for the container is also included in the present apparatus and is formed with a nitrogen delivery system that communicates with the resilient port located at the base of the container. Specifically, the support is rotatably attached to the housing and includes a passageway therethrough, which conducts gaseous nitrogen to the port at the base of the container.

It may be apparent that a novel and useful apparatus for infusing gaseous nitrogen from a source to a beverage has hereinabove described.

It is therefore an object of the present application to provide an apparatus for infusing gaseous nitrogen from a source into a beverage that combines the steps of infusion and dispersion of nitrogen gas into a beverage.

Another object of the present application is to provide an apparatus for infusing gaseous nitrogen from a source into a beverage that may be used to provide a cold brew coffee without the use of a specialized tap or spout.

Another object of the present application is to provide an apparatus for infusing gaseous nitrogen from a source into a beverage which provides optimal nitrogenizing after the beverage is dispensed, i.e. a post-dispensing nitrogenizing process.

Another object of the present application is to provide an apparatus for infusing gaseous nitrogen from a source into a beverage that utilizes an agitator that may take the form of a high revolution mixing tool, in combination with novel baffles positioned within the chamber of the container to restrict vortex formation in the drawing of ambient air into the container.

Another object of the present application is to provide an apparatus for infusing gaseous nitrogen from a source into a beverage that utilizes a rotating shaft in combination with one or more baffles within a container and eliminates formation of a vortex with ensuing cavitation, thus preventing aeration of the beverage or liquid within the container chamber by ambient air.

Another object of the present application is to provide an apparatus for infusing gaseous nitrogen from a source into a beverage that eliminates infusion of oxygen and carbon dioxide from the ambient atmosphere into the beverage being infused within a container, simply and effectively.

Another object of the present application is to provide an apparatus for infusing gaseous nitrogen from a source into a beverage in which the amount of agitation and the rate of delivery of nitrogen gas into the container are easily controlled at the same time.

Another object of the present application is to provide an apparatus for infusing gaseous nitrogen from a source into a beverage in which a rotating shaft is employed to create pressure and shear in the liquid adjacent to one or more baffles located in the container.

A further object of the present application is to provide an apparatus for infusing gaseous nitrogen from a source into a beverage which may take the form of coffee, milk products, juices, and the like.

Yet another object of the present application is to provide an apparatus for infusing gaseous nitrogen from a source into a beverage which includes a stationary container that is easily tapped and reused without removing the container from the apparatus housing.

The application possesses other objects and advantages especially as concerns particular characteristics and features thereof which will become apparent as the specification continues.

### BRIEF DESCRIPTION OF THE SEVERAL VIEWS OF THE DRAWINGS

FIG. 1 is a front elevational view of the apparatus of the present application.

FIG. 2 is a top plan view of the lid portion of the apparatus of the present application.

FIG. 3 is a side elevational view of the lid portion of the apparatus of the present application.

FIG. 4 is a bottom plan view of the lid portion of the apparatus of the present application.

FIG. 5 is a side elevational view of the container of the apparatus of the present application mounted on a support.

FIG. 6 is side elevational view of the apparatus of the present application with the container shown in phantom.

FIG. 7 is a partial top, perspective view of the bottom portion of the apparatus of the present application illustrating the positioning of the nitrogen port and agitator shaft, and baffles.

FIG. 8 is a partial side elevational view of the motor mount plate and distending shaft with a portion of the container shown in phantom.

FIG. 9 is an enlarged sectional view taken along line 8-8 of FIG. 6.

FIG. 10 is a top right partial perspective view of the support showing the hinge of the support and the nitrogen port element.

FIG. 11 is a sectional view taken along line 11-11 of FIG. 10.

FIG. 12 is a sectional view depicting the interaction of the base of the container with the support detailing the port for delivery of nitrogen gas.

For a better understanding of the application, reference is made to the following detailed description of the preferred embodiments which should be referenced to the prior delineated drawings.

### DETAILED DESCRIPTION OF THE PREFERRED EMBODIMENTS

Various aspects of the present application will evolve from the following detailed description of the preferred embodiments thereof which should be referenced to the prior delineated drawings.

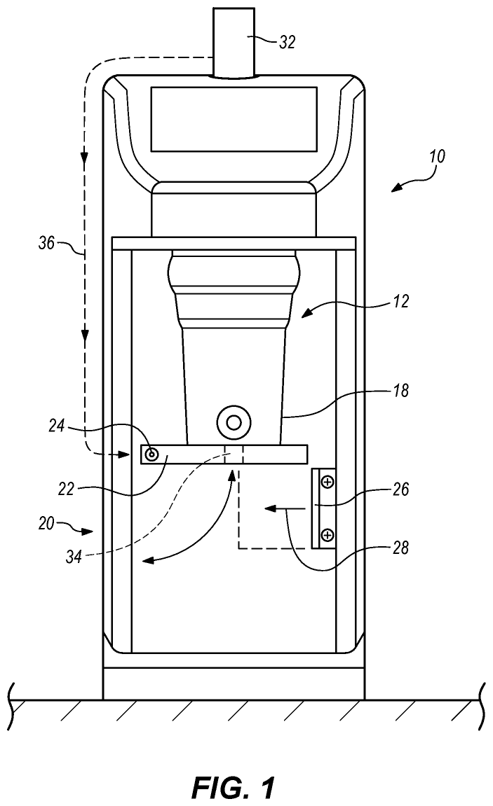

The apparatus as a whole is depicted in the drawings by reference character 10. Apparatus 10 includes, as one of its elements, a container 12. Container 12 includes a chamber which is intended to hold a beverage. Container 12 is also formed with a base 16 and a side portion 18 extending therefrom, FIGS. 1 and 5.

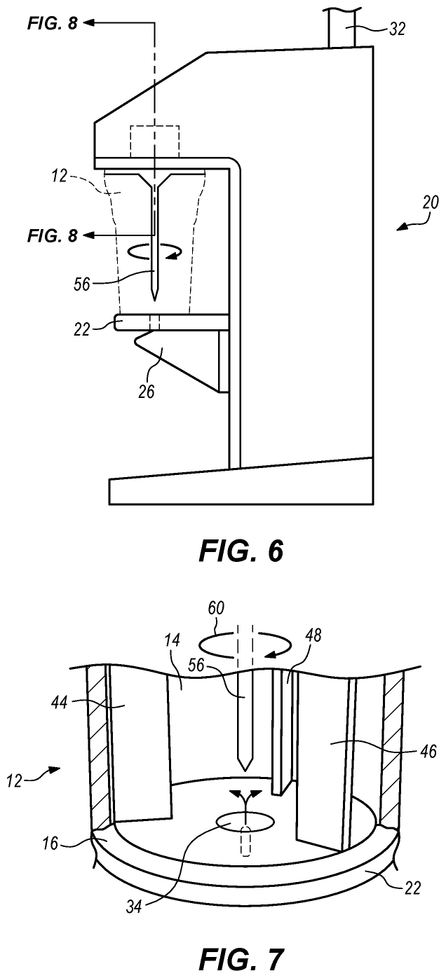

Apparatus 10 is also provided with a housing which provides support 22 for container 12 that is rotatable about a hinge 24. A brace 26 is able to swing outwardly from housing 20 and hold support 22 in a generally horizontal position, directional arrow 28, FIGS. 1 and 6.

Container 12 is also provided with an optional discharge or spout 30 which permits the egress of beverage from chamber 14 of container 12. A source of gaseous nitrogen 32 delivers the same to the vicinity of support 22 and to a port 34 at support 22 which directs gaseous nitrogen to the chamber 14 of container 12. The passage of gaseous nitrogen into chamber 14 will be described in greater detail as the specification continues. In any case, a conduit 36 between nitrogen source 32 and support 22 is of conventional configuration.

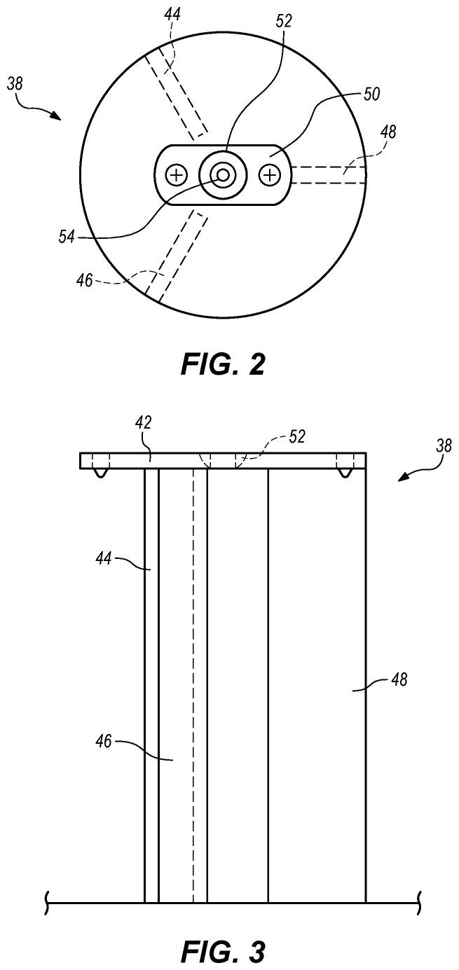

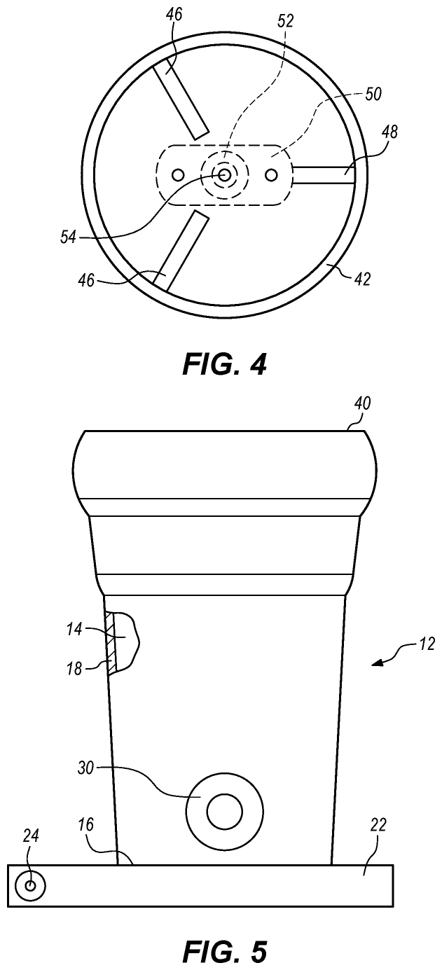

Turning to FIGS. 2, 3, and 4, it may be observed that a lid 38 is depicted and is intended to fit over the top 40 of container 12. Lid 38 includes a top 42 and baffles 44, 46, and 48 depending therefrom. Lid 38 is also formed with a connector 50 that is constructed with a concave fitting 52 having an aperture 54 through the same. Aperture 54 is intended to allow an agitator 56 to extend therethrough and into the chamber 14 of container 12. The details of agitator 56 will be discussed as the specification continues. Needless to say, placement of lid 38 on top 40 of container 12 would allow baffles 44, 46, and 48 to extend within chamber 14 of container 12. FIG. 7 depicts the relationship of agitator 56, baffles 44, 46, and 48, and nitrogen gas port 34. Baffles, 44, 46, and 48 may alternately extend from the base 16 of container 12.

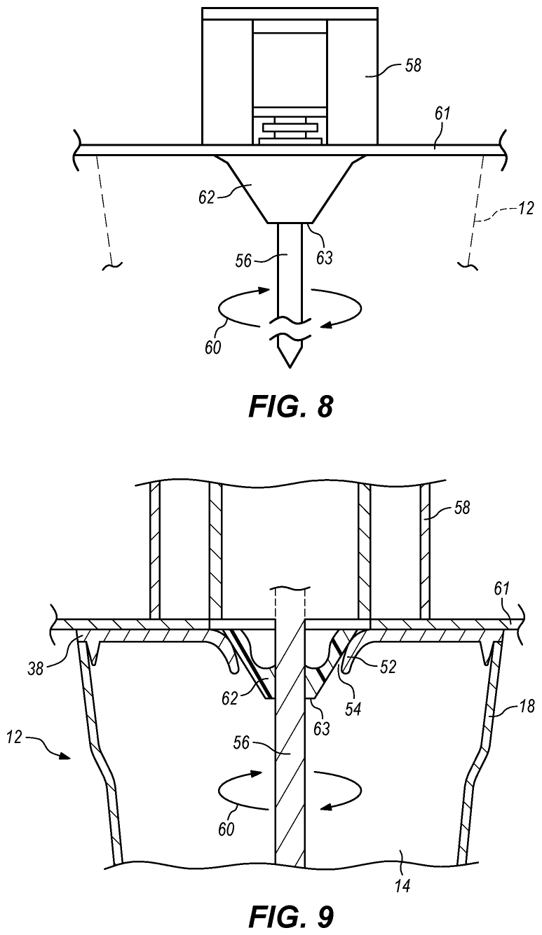

With reference now to FIGS. 8 and 9, the agitator 56 operation is detailed. Agitator 56 is turned by a motor 58, according to directional arrows 60. Plate 61 includes a conical protrusion 62 that appends therefrom. Protrusion 62 nests or fits within concave fitting 52 of lid 38 and has an aperture 63. Agitator 56 then extends through aperture 54 of concave fitting 52, aperture 63 of protrusion 62, and into chamber 14 of container 12.

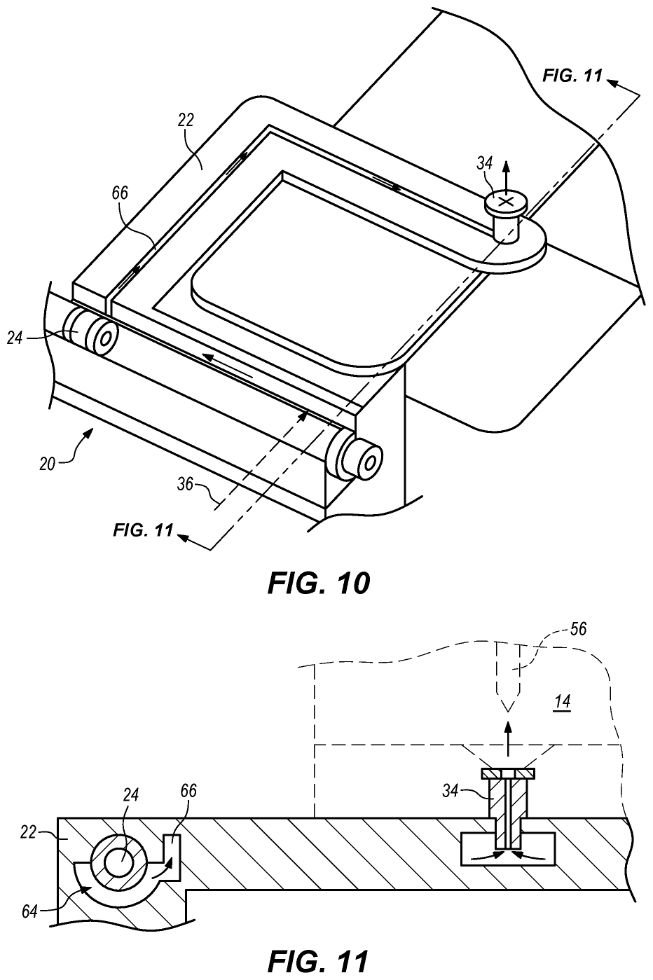

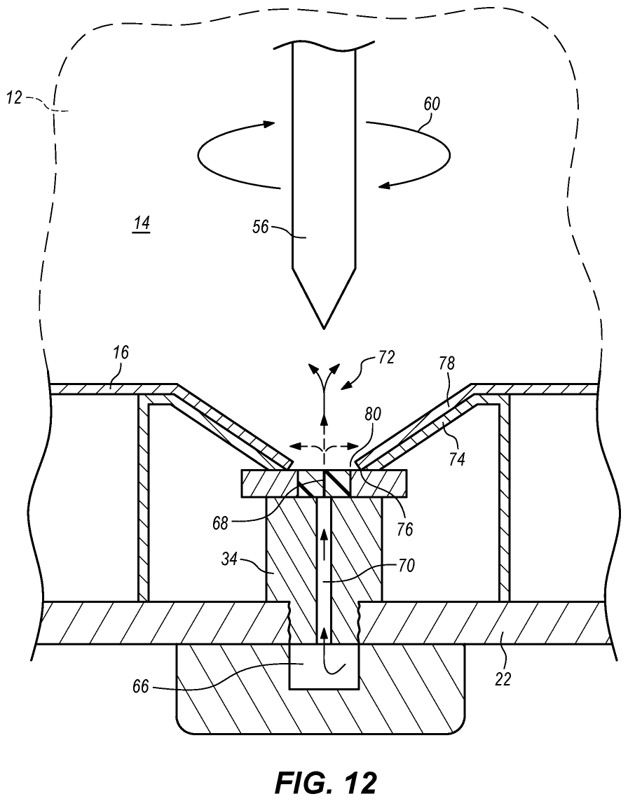

Turning now to FIGS. 10 and 11, it may be observed that delivery of nitrogen gas from nitrogen gas source 32 is illustrated. Nitrogen gas conduit 36 (in phantom) delivers nitrogen gas to channel 64, which extends around hinge 24 at support 22. U-shaped trough 66 then directs nitrogen gas to port 34. It should be noted that support 22 is depicted in section to show the travel of nitrogen gas to port 34. With further reference to FIG. 12, it may be seen that port 34 is formed of resilient material and includes an orifice 68 which leads to trough 66 and a tunnel 70 through nitrogen gas port 34. The pressure of nitrogen gas travelling through trough 66, tunnel, 70, and orifice 68 expands or enlarges orifice 68 and predetermines the amount of nitrogen gas that passes into chamber 14 of container 12. Directional arrows 72 show the travel of nitrogen gas from port 34 and into chamber 14 of container 12. It should be seen that the regulation of the turning or activity of agitator 56 is controlled by the electrical feed to motor 58 in a conventional manner.

FIG. 12 further details the delivery of nitrogen gas to chamber 14 of container 12. Support 22 possesses a protrusion 74 with an opening 76. Likewise, base 16 of container 12 includes a conical protrusion 78 with an opening 80. Gaseous nitrogen from port orifice 68 passes into chamber 14 of container 12 at a controlled rate in the vicinity of agitator 56 and baffles 44, 46, and 48, FIG. 7.

In operation, the user places the nitrogen gas source 32, which may be a canister, within container 12. A conventional outlet to nitrogen gas source 32 allows the passage of nitrogen gas through conduit 36 and into channel 64 adjacent hinge 24. Again, the opening of nitrogen gas source 32 is achieved by conventional known valving. Support 22 is then swing upwardly by the use of hinge 24 and supported by brace 26 in a relatively horizontal position. Container 12, holding a beverage which may be cold brew coffee and the like, is then placed atop support 22 such that support 22 communicates with the chamber 14 of container 12, best shown in FIG. 12. Agitator 56 is then activated via motor 58 to create a shearing effect on the beverage within container 12. The control of the turning of agitator 56 and the presence of baffles, 44, 46, and 48 depending from lid 38 avoids the creation of cavitation. Thus, any infusion of ambient air containing oxygen, carbon dioxide, and other gases is prevented by the combination of baffles 44, 46, and 48 and the turning of agitator 56. The quantity of nitrogen gas entering chamber 14 via U-shaped trough 66, tunnel 70, and slightly opened orifice 68 of port 34 is controlled by the determination of the pressure through conduit 36 from nitrogen source 32. The resulting drink from the beverage in chamber 14 of container 12 following nitrogen infusion possesses a desirable taste. For example, in the case of cold brewed coffee, such coffee is perceived as being creamier and sweeter than normal coffee.

While in the foregoing, embodiments of the application have been set forth in considerable detail for the purposes of making a complete disclosure of the application, it may be apparent to those of skill in the art that numerous changes may be made in such details without departing from the spirit and principles of the application.

What is claimed is:

1. An apparatus for infusing gaseous nitrogen from a source into a beverage, comprising:
a container, said container comprising a chamber for the beverage, said container being formed by a base and a side portion extending therefrom;
at least one baffle located in said chamber and is positioned along said side portion of said container;
a port located in said base of said container, said port permitting the passage of a gaseous nitrogen from the source to said chamber of said container;
an agitator, said agitator creating a shear force on the beverage in said chamber of said container, said agitator being located adjacent said port and said at least one baffle;
a first controller for regulating the activity of said agitator, and a second controller for regulating the rate of entry of the gaseous nitrogen into said chamber of said container through said port;
a support for said container, said support including an injector communicating with said port located in the base of said container and the source of nitrogen; and
a housing, said support being rotatably connected to said housing.

2. The apparatus of claim 1 in which said at least one baffle comprises a plurality of baffles.

3. The apparatus of claim 2 which additionally comprises a lid, said plurality of baffles depending therefrom and extending into said chamber of said container.

4. The apparatus of claim 3 in which said lid includes a concave fitting having an aperture therethrough, said agitator including a shaft, said shaft extending through said aperture in said concave fitting and into said chamber of said container.

5. The apparatus of claim 4 which further comprises a motor for turning said shaft of said agitator, said motor being mounted on a plate located in said housing, said plate further comprising a protrusion having an opening therethrough, said protrusion mating with said concave fitting of said lid, said shaft extending through said opening in said protrusion and said aperture of said concave fitting of said lid.

6. The apparatus of claim 5 in which said protrusion is conical.

7. The apparatus of claim 1 in which said port of said container comprises an element of resilient material, said element including said port as an orifice being capable of enlarging under pressure of the gaseous nitrogen from said source and collapsing in the absence of gaseous nitrogen from source.

8. The apparatus of claim 1 in which said container includes a discharge for permitting the egress of beverage from said chamber of said container.

9. The apparatus of claim 1 which additionally comprises a hinge rotatably connecting said support to said housing.

10. The apparatus of claim 1 which additionally comprises a passageway through said support for conducting gaseous nitrogen to said port.

11. The apparatus of claim 1 in which said support further comprises a concave retainer with an aperture therethrough, said container further comprises a protrusion having an opening therethrough, said protrusion mating with said concave retainer of said support to allow gaseous nitrogen from said port to pass through said aperture of said concave retainer and said opening through said protrusion to said chamber of said container.
